(19) United States
(12) Patent Application Publication
(10) Pub. No.: US 2015/0172145 A1
(43) Pub. Date: Jun. 18, 2015

(54) IMPACT PREDICTION OF SOCIAL MEDIA INTERACTION

(71) Applicant: Avaya, Inc., Basking Ridge, NJ (US)

(72) Inventors: David Skiba, Golden, CO (US); George Erhart, Loveland, CO (US); Lee Becker, Boulder, CO (US)

(73) Assignee: Avaya, Inc., Basking Ridge, NJ (US)

(21) Appl. No.: 14/133,251

(22) Filed: Dec. 18, 2013

(51) Int. Cl. H04L 12/26; H04L 29/08

(52) U.S. Cl. CPC H04L 43/04; H04L 67/10

(57) ABSTRACT

Social media websites occasionally experience a spike in activity known as a viral event or “going viral.” While some viral events are purely entertainment based, such as the latest cat video, other viral events can be specifically relevant to a domain, such as an industry or business. A social media event, such as a common thread of posts, may attract no more than the usual amount of interest or it may be about to “go viral.” As provided herein, social media events may be monitored and evaluated for virality. If an event indicates it will go viral, but has not yet done so, an affected party may be made aware of the event and take steps to curtail negative viral events or to leverage, or even promote, positive viral events.

### FIELD OF THE DISCLOSURE

The present disclosure is generally directed toward analyzing social media posts and more particularly, to predicting, and optionally responding to viral events.

### BACKGROUND

Social media sites are typically Internet locations where people interact. In most social media sites, people can create, exchange, and share ideas and information. With social media, people can post comments and media. Subsequent viewers may “like,” “retweet,” share, and post additional comments on prior posts, which may be an indication of agreement or disagreement with the sentiment of the prior post. For example, on a cable television provider's website, a poster might put up a comment, “Your bandwidth sucks and I can't watch TV!” which might garner 50 likes in agreement if other users are having similar issues. Sometimes the comments can, “go viral” (e.g., blow up to become wildly popular). A post might lead to a big comment chain, and therefore become viral. For many businesses, opinions are acutely important to their ongoing success. Social media has the power to spread opinions very quickly and a business may fail as a result of a post that leads to a negative viral event. Conversely, a business may be the subject of a positive viral event and benefit from the positive opinion it brings.

### SUMMARY

It is with respect to the above issues and other problems that the embodiments presented herein were contemplated.

The present disclosure seeks to advance the state of the art and solve the problem of posts, “going viral,” and potentially harming a business or entity. If a post does appear to be “blowing up,” and showing an indication of going viral, the post may be routed to triage such events and reduce the impact of a negative viral event. Also provided is a predictive model that can analyze content, sentiment class, number and direction of comments, and velocity as well as derivatives of the content.

Companies want to protect branding and reputation. Many companies monitor social media sites and respond to posts as a form of protection. Unfortunately, a company can waste a lot of time and resources looking through posts for aspects that require a response. Even worse, if a post or topic goes viral, a tremendous amount of damage can be done to a company, sometimes to the point of being unrecoverable. In addition to detecting a post and/or topic that may go viral, certain embodiments herein provide a means to give the post and/or topic special priority/escalation for handling in a contact center, and thereby providing a route for triage before things get out of hand. Conversely, companies want to participate in positive conversations that go viral and potentially mine the information for marketing strategies and other benefits.

As an advantage of the disclosure herein, companies may be provided with a tool to predict when posts and/or topics may go viral. “Going viral” or a “viral event” is an atypical level of popularity of a particular post or topic within a domain or related to a particular subject, such as a business or a product of a business. A viral event may be positive (e.g., promoting or beneficial to the entity) or negative (e.g., disparaging or harmful to the entity). Within a domain or customer based model, a measurement is made of the velocity of the number and direction of sentiment bearing comments as well as any and all other content, including derivatives, spikes, geographic velocity jumps, temporal properties of actions, etc. The model may also take into account metrics for personal, domain, and other cultural norms (e.g., posts about cats have a higher viral threshold than posts about a delayed flight). Once a viral event has been detected, that is, a current event has been detected that has an attribute common to the early stage of at least one past viral event, measures may be taken and, if successful, the viral event does not become viral or becomes viral to a lesser extent that it otherwise would have.

Initial system training is provided to create a domain space virality model, such as by examining a number of past postings on social media websites. Viral posts may contain patterns and characteristics beyond words or phrases which may also be examined. For example a post may have a meaning to the words in the form of a sentiment (e.g., love, like, neutral, dislike, hate, etc.). Sentiment may be considered along with the history in training the initial model and later, in determining which current events are of interest. The model may also contain a priority-based likelihood. A supervisor may also be incorporated to provide feedback to assist with the model training and/or tuning.

The system is additionally designed to be a learning model. Feedback would be given to train the model as things change over time, including names, products, common words, etc. The language/words could be captured and automatically used to update the system and/or an administrator could update the system manually using prior “like” responses and new comments. The learning model is operable to execute in all new items (likes, posts, retweets, etc.), applying regression modeling, posts of analysis, company action taken, etc. If an event the system detects does go viral, it would be tagged and added into the model. If something was tagged and there was little to no activity, the tag and any related information might be removed from the model or identified as an indicator of a non-viral event. The model is configurable to watch for spikes, abnormalities and outliers, and special events like holidays, etc. Such features may also be extended based on the domain.

Once a viral event is identified, the event and/or specific posts comprising the event could be routed to an agent and/or supervisor for special handling. Specially trained contact center resources may then deal with the post appropriately and quickly and, hopefully, long before becoming “viral.” Special handling by an agent may comprise operations of a human and/or automated agent. Special handling might include removal of a post, blocking a user, immediate response to a post, matching a post to a person, responding in a different medium, and so on.

For example, Sarah posts a positive comment regarding her pre-wedding experience at the Sunrise Day Spa on their social media page. Twenty other customers “like” her post over the course of two hours, which is significantly more than average for Sarah's posts. The Sunrise Day Spa uses the system to detect the comment, giving the spa an opportunity to respond with interactive positive banter. An opportunity is also created to improve and target marketing both generally and specifically for wedding services based on the feedback. The spa sends Sarah a “thanks” in the form of a coupon or discount code for initiating the positive public relations.

In another example, Tom posts on his personal media page that he killed Jerry with an ABC brand knife and posts a strange, grainy video. The system detects the comments and endorsements of the video may indicate a viral event and alerts ABC company that it may have a serious publicity problem on its hands. A work item is created and routed to a special agent for handling. The agent to whom the work item is assigned is a specialist, specifically trained for damage control on social media. The agent connects Tom to a customer profile (based on his social media ID) and calls Tom right away. During this time, the post and the video are starting to cross time zones. It has become the buzz, with some negative sentiment expressed about the ABC company. After a conversation, the agent discovers that the entire post/video was a joke. Tom, at the urging of the agent, immediately pulls the information and posts an apology. ABC issues a statement that the post was a hoax and responds to a few of the negative posts on other sites. The entire incident lasts only for one day, and ABC's reputation is saved.

In one embodiment, a method is disclosed, comprising: accessing a number of historical social media posts; selecting a historic viral event comprising a first number of the historical social media posts; identifying a historic viral signature from the historic viral event; monitoring a social media website for a number of current social media posts; determining the degree of a first match between the number of current social media posts and the historic viral signature; and upon determining the degree of the first match indicates a current viral event, performing a first response.

In another embodiment, a system is disclosed, comprising: a processor; a database a network connection operable to connect the processor to a social media website; wherein the processor is operable to access a number of historical social media posts, select a historic viral event comprising a first number of the historical social media posts; identify a historic viral signature from the historic viral event; and populate a database with the historic viral signature.

In yet another embodiment, a non-transitory computer readable medium with instructions, is disclosed that when read by a computer cause the computer to perform the following method: accessing a number of historical social media posts; selecting a historic viral event comprising a first number of the historical social media posts; identifying a historic viral signature from the historic viral event; monitoring a social media website for a number of current social media posts; determining the degree of a first match between the number of current social media posts and the historic viral signature; and upon determining the degree of the first match indicates a current viral event, performing a first response.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term, “viral” or “viral event” as used herein refers to a number of social media posts containing a sentiment and/or endorsements of the posts that has become, or is predicted to become, atypically popular within a given domain, topic, and/or subject. An event is viral if the number posts and/or associated endorsements within a certain period of time are greater than the norm for like items within the domain. The exact quantity and/or rate to declare an event viral is a matter of design choice. For example, an entity wanting to examine events at the earliest indication of an outbreak may have a very low threshold of virality, such as a quantity/rate that is one standard deviation or less from the norm. Another entity may want to examine outbreaks only when there is a high degree of certainty of virality, such as when the quantity and/or rate is several standard deviations greater than the norm. Still another entity may consider the domain to be very broad (e.g., all business and leisure travel) whereas another entity may consider the domain to be more narrow (e.g., air travel, air travel on Alpha Airlines, etc.). Similarly, the same entity may use one definition of domain and/or viral for one purpose and another definition for another purpose.

Factors, such as domain and cultural norms may also help determine virality. For example, an event representing a significant impact on a small number of people (e.g., a cancelled flight) may become viral within the domain of air travel or, even more narrowly, air travel with respect to the specific airline that cancelled the flight or air travel with respect to the planned origin and/or destination of the cancelled flight. However, such events may never be considered viral if included in other, more popular domains, such as cat videos and celebrity gossip.

The term “endorsement” as used herein refers to a post that takes the form of an acknowledgement or explicit endorsement of an existing message or media (e.g., a “post”). Endorsements include “like,” share, re-Tweet, comment, thumbs-up, high rating (e.g., 4 starts out of 5, etc), or other expression whereby the viewer of a post may indicate their interest, support, acknowledgement, etc. Endorsements may also be implied, such as by a number of views. For example, individuals may be reluctant to “like” a posting of a tragic event but if the number of views is atypically large, endorsements may be implied. In should be noted that what is being endorsed is generally determined by the endorser and may or may not be an endorsement of the particular event or subject of the post. An endorsement may simply reflect the endorser's belief that a particular post is newsworthy or interesting.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a first chart of the frequency of events in accordance with embodiments of the present disclosure;

FIG. 3 depicts a second chart of the frequency of events in accordance with embodiments of the present disclosure; and

FIG. 4 depicts a process in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedent.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

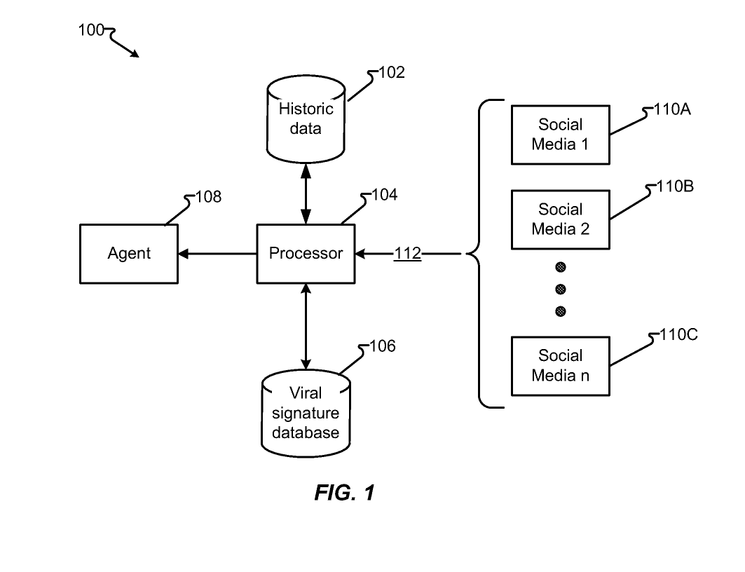

With reference now to FIG. 1, system 100 will be described in accordance with embodiments of the present disclosure. In one embodiment, system 100 is operable to identify a number of viral signatures and populate entries in viral signature database 106 accordingly. Processor 104 may then monitor current posts 112 and if one or more posts match an entry in viral signature database 106, a viral event may be identified which comprises the one or more posts. In a second embodiment, system 100 is operable to detect a viral candidate and signal agent 108 to respond accordingly. Agent 108 may take actions to mitigate the virality of the viral candidate, if negative, or promote or otherwise leverage the viral candidate, if positive. After taking such an action, and waiting for a suitable duration of time, processor 104 may determine if current posts 112 matches a viral signature database 106 entry and may notify agent 108 to make a subsequent and/or alternative response. Agent 108 may decide not take any action. For example, a viral candidate's virality may fade due to actions taken by agent 108 or for unrelated reasons. Agent 108 may also have believed the viral candidate was erroneously selected chose to override the decision to manage the event as viral and let the viral candidate live or die on its own. Agent 108 may also believe additional information is required prior to making a response. In certain circumstances it may be difficult to credit any particular action with suppressing the viral candidate. In one embodiment, system 100 is in a learning mode and allowed to execute, but without taking any action, and thereby determine which ones of the viral candidate events did or did not become viral.

In another embodiment, historical data 102 is accessed by processor 104. Historical data 102 provides events, such as one or more threads of posts and endorsements, to processor 104 associated with historical viral and/or non-viral events. Processor 104 may then derive a set of viral signatures that foreshadowed a first number of posts going viral and are optionally distinguishable from other posts, where virality did not result. Processor 104 may then populate viral signatures database 106 with rules whereby current posts 112 may be matched to entries therein and, according to the match, identified as viral candidates or not.

In another embodiment, viral signatures database 106 and current posts 112 are accessed by processor 104. Current posts 112 are one or more posts from a number of social media websites 110. Processor 104 may then compare current posts 112 with entries in viral signature database 106. If processor 104 determines a match exists between current posts 112 and an entry in viral results database 106, within a previously determined margin of error, processor 104 may identify current event 112 as a viral event and agent 108 is notified to respond accordingly.

The specific rules in viral signatures database 106 are variously embodied. In one example, historic data 102 contains a number of posts, each with a number of endorsements, with a common post content and sentiment, such as, “I'm mad at Alpha Airlines, they cancelled my flight.” However, historic data 102 reveals that certain posts became viral while others did not. Analysis techniques utilized by processor 104 determined that a post was more likely to become viral if the creator of the post had an extensive Internet presence and/or references in entertainment and business trade websites (e.g., the post creator was a highly influential person, such as a business and/or entertainment celebrity). Processor 106 then created an entry in viral signatures database 106 to indicate that posts within the domain of air travel and/or cancelled flights, when created by a celebrity, are more likely to become viral than those created by non-celebrities. Accordingly, if current posts 112 contain posts from celebrities, processor 104 may then match the sender to a listing of individuals in historic data 102 and/or sources of such individuals, and indicate the event matches a viral signature.

In another embodiment, at least one rule in viral signatures database 106 is based upon post content and/or sentiment consistency of over time. In one embodiment, processor 104 accesses historic data 102 of a known historic viral event. Processor 104 determines that an earlier post, and a later post, are within the same posting event or thread but separated by a duration of time, geographic distance, or a number of intervening posts. If the later post substantially maintains the same sentiment and/or subject as the earlier post, a viral candidate may be determined accordingly.

More specifically, post may be more likely to become viral events if the community of viewers of the posts is, or becomes, “fired up” over the same issue and with the same sentiment. Conversely, the more fragmented the views of the community, the more likely virality will be curtailed on its own as individuals contribute new posts that change topics and/or contradict the sentiment of posts from other members of the community. For example, a rumored plan by Alpha Airlines would reconfigure planes to have four seats in place of three. The first post, of which there may be many first posts from various posters forming the event, is very negative with regard to Alpha Airlines and the rumored seating configuration changes. A later generation of posts (e.g., posts at a later time and/or posts that directly follow a prior post) are similarly negative and stay on topic. After many generations of posts, a small portion of posts have left the topic of seating configurations on Alpha Airlines for other topics (e.g., on-time rate, food on Beta Airlines, lost luggage on Gamma Airlines, etc.) and a minority portion have a positive sentiment (e.g., “Great, tickets will have to be a lot cheaper!”). However, for the majority of the later posts, even after a substantial number of generations and/or passage of time, still have a negative sentiment and are still directed towards the topic of Alpha Airline's rumored seating configuration. Accordingly, the event became viral. Therefore, processor 104 may encounter current posts 112 whereby a later post is substantially similar in sentiment and content to an earlier post and identified as a viral candidate.

In another example, a non-viral even is detected. A first post originates which professes great enjoyment (e.g., a positive sentiment) in seeing a particular movie. However, within a couple generations a substantial number of posts have either the opposite sentiment or have drifted to other topics, such as like or dislike for a particular actor, preference of another movie, etc. A number of later posts may have a neutral sentiment and further fragmenting the tread of posts. Within a few more generations, the thread of posts are difficult to associate with the parent post and the event does not become viral. Therefore, processor 104 may then create an entry in viral signature database 106 that determines that if a thread fragments as to subject or sentiment, within a predetermined number of generations and/or time, such an event is not identified as a viral candidate.

Similarly, if posts occurring in one geographic region and cross into another geographic region intact (e.g., with the subject and sentiment substantially unchanged from the original) a viral candidate may be identified. In another embodiment, trends may begin to cross networks. For example, social media website 110A may have an event 112 that is echoed by posts on social media website 110B. Therefore, the event may be a viral candidate as interest has been determined to cross networks.

Once a set of current posts 112 is determined to match a rule indicating a viral candidate, processor 104 may respond accordingly. In one embodiment, processor 104 notifies agent 108 to take action. Agent 108 may contact the poster of at least one of the earlier posts to gather information and/or attempt to moderate the viral trend, if negative. Similarly, agent 108 may want to show appreciation to the poster of an event that may be positively viral. Agent 108 may also provide posts to one or more of social media websites 110 to moderate or leverage the viral trend. Agent 108 may have the ability to delete a post on one of social media websites 110 and does so. The effect of agent's 108 response may then be evaluated. If, after waiting an appropriate amount of time, processor 104 again compares current event 112 to entries in viral signatures database 106 to determine if the rate of the viral trend has changed. Agent 108 may then be notified to take appropriate subsequent action.

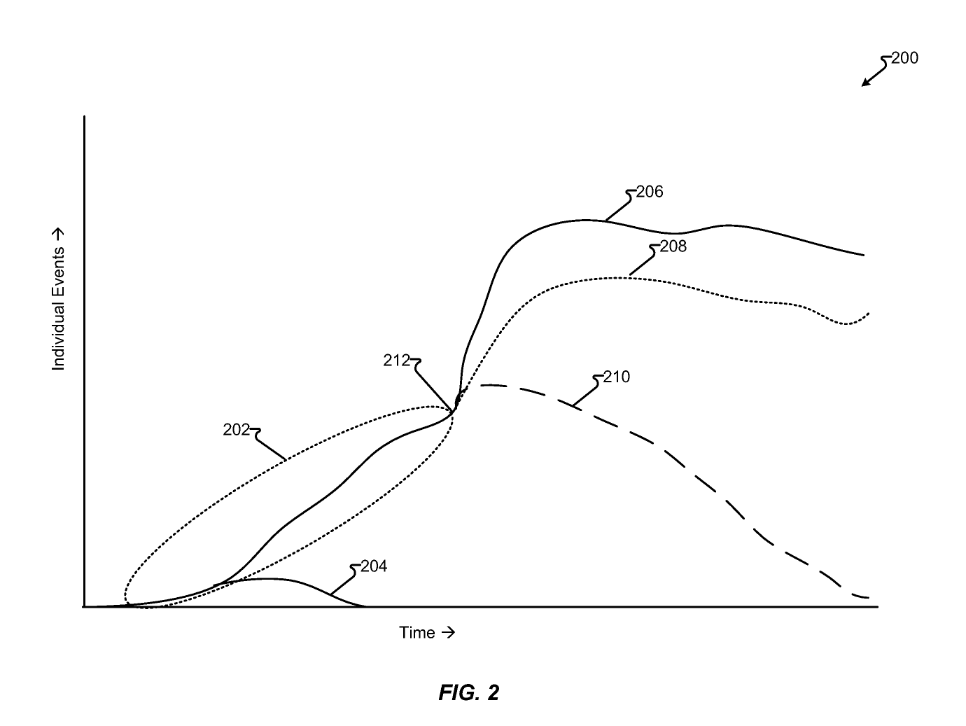

With reference now to FIG. 2, frequency chart 200 will be described in accordance with embodiments of the present disclosure. A viral trend comprises a number of events (e.g., posts and/or endorsements of posts) with a common origin or motivation. An event may have an origin in a single posting (e.g., a horrifying image with the caption, “Look what I found in my food!”) or it may be a commonly themed posting by a relatively limited number of individuals (e.g., two-hundred individuals tweeting their anger over a cancelled flight caused by members of the cabin crew getting into an altercation).

Current posts 112 may be restricted to a particular domain, subject, keyword or other subject-limiting aspect prior to, or integral to, determination of whether the posts are a viral candidate. Current posts 112 may then be analyzed to determine the presence of a viral indication. Curves 202, 204, 206, 208, 210 illustrate example curves of the number of current posts 112 having a sentiment and/or content of interest, plotted over time. In one embodiment, curve 202 may be described as a mathematical function and the function matched against other functions described in viral signature database 106. Other determining aspects of curve 202 may include the velocity (e.g., first derivative), change in velocity (e.g., second derivative), and so on. The degree of match may also be described with respect to a certain tolerance or margin of error.

In one embodiment, current posts 112 produces curve 204 and is matched against curves in viral signature database 106. Curve 204 fails to match a viral signature in viral signature database 106 and no action is taken. The event associated with curve 204 fades of its own accord.

Curve 202, at point 212, is determined by processor 104 to be a viral candidate, whereby processor 104 notifies agent 108 who takes an action. Following the action at point 212, the result of the action may be as expected or counter to expectations to varying degrees.

Curves 206, 208, and 210 show three potential outcomes of the action taken by agent 108 at point 212. On one embodiment, curve 210 illustrates a successful attempt by agent 108 to moderate the virality of a negative viral event. In another embodiment, curve 206 illustrates a successful attempt by agent 108 to magnify the virality of a positive viral vent. In another embodiment, curve 208 illustrates the agent 108 having no affect on the virality of a viral event. As can be appreciated, other embodiments are also provided whereby the success or failure of agent 108 may increase, decrease, inversely increase or decrease (e.g., backfires), or has no effect. In a further embodiment processor 104 may determine the effectiveness of the actions taken by agent 108 to better estimate the success of similar actions with respect to future viral events and preserve such impact.

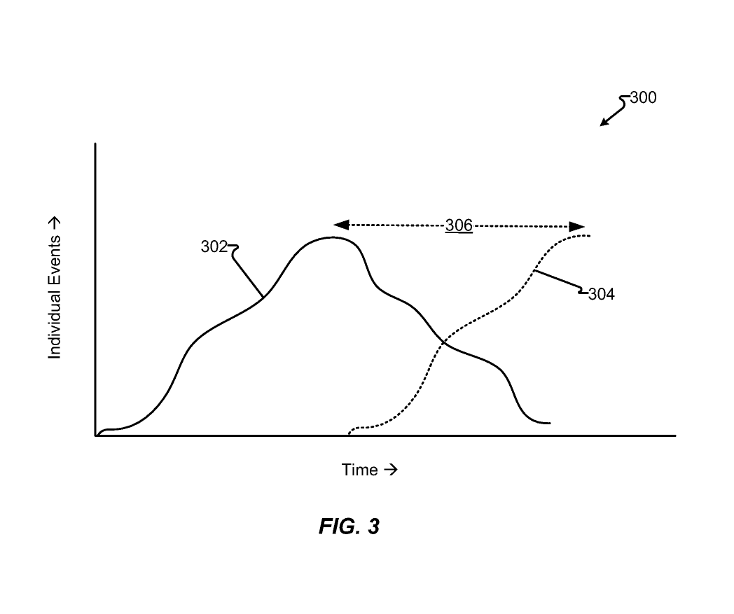

With reference now to FIG. 3, frequency chart 300 will be described in accordance with embodiments of the present disclosure. In one embodiment, curve 302 illustrates a frequency of current posts 112 occurring within a first time zone. Curve 304 illustrates a frequency of similar events for a second time zone. Difference 306 is approximately one hour. As is generally known, certain human activity occurs more frequently during certain local times. For example, many individuals break from work, school, or other activities around noon local time for lunch. During which time a predictable pattern in the change of use in social media may be expected. For example, individuals on their lunch break may increased access computers, smartphones, or other devices and utilize those devices to access social media. An event in a first time zone may get its first toehold to being viral event during one of these times of availability. As time passes, individuals within the same time zone may be returning to their prior activities and, accordingly, the frequency of events begins to decrease. This may be a sign that the event is fading, however, if echoed by a second time zone (e.g., curve 304) as those individuals enter a similar time of availability (e.g., lunch), interest overall may be increasing and, therefore, a viral candidate may be identified.

In another embodiment, difference 306 may be more than one hour, such as a day or several days. For example, a decrease in events on a Friday evening may indicate the event is not going viral, however, interest may resume on the following Sunday evening. As may be encountered, such as in the United States, Friday evening may occupy more individuals with weekend plans, returning home from work, or other activities whereby their attention is directed away from social media. Whereas on a Sunday evening, more individuals may be returning for weekend activities, resting, preparing for the next work week and otherwise have more time for social media. Therefore, a decrease in interest on a Friday may not have much significance, whereas an increase on a Sunday evening may have more significance, especially if echoed across multiple time zones.

Accordingly, processor 104 may determine that current posts 112 showing, at least a spike in events, at approximately the same local time and/or day in at least two time zones, may be an indicator of continued interest, and therefore, indicate virality.

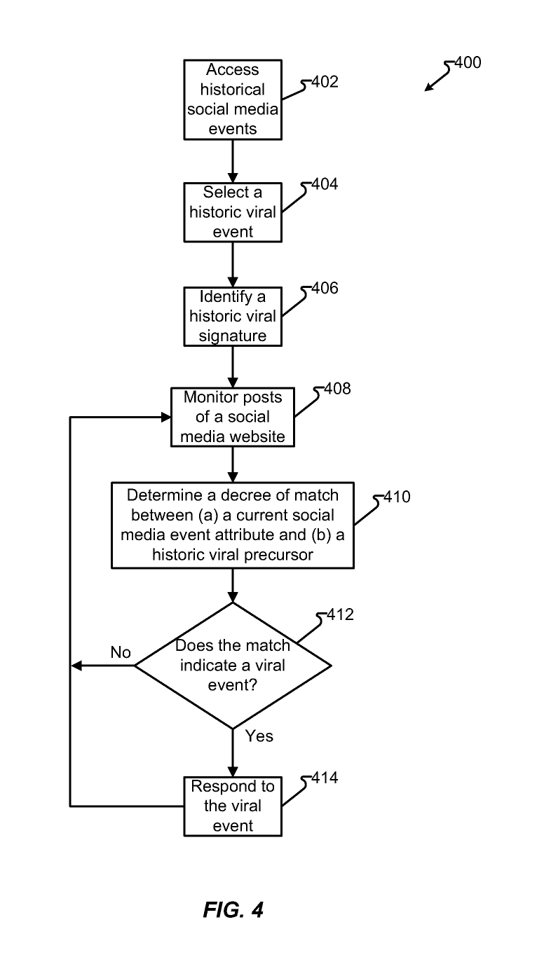

With reference now to FIG. 4, process 400 will be described in accordance with embodiments of the present disclosure. In one embodiment, step 402 accesses historical social media events, such as by processor 104 accessing historical data 102. Step 404 selects a historic viral event and step 406 identifies a historic viral signature associated with one or more posts of the historic viral event, and optionally stores the identified historic viral signature in viral signatures database 106.

Step 408 then monitors at least one social media websites 110 for current posts 112. Step 410 determine if there is a match and/or the degree of match between the current event and a historic viral event. Step 412 determines if the match indicates a viral event within viral signature database 106. If step 412 determines the answer is no, processing may then continue at step 408. If the answer is yes, step 414 causes a response to the viral event and, from there, processing may then continue at step 408.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
accessing a number of historical social media posts;
selecting a historic viral event comprising a first number of the historical social media posts;
identifying a historic viral signature from the historic viral event;
monitoring a social media website for a number of current social media posts;
determining the degree of a first match between the number of current social media posts and the historic viral signature; and
upon determining the degree of the first match indicates a current viral event, performing a first response.

2. The method of claim 1, further comprising:
selecting a historic non-viral event comprising a second number of the historical social media posts; and
wherein identifying the historic viral signature, further comprises, identifying an attribute of the historic viral event that is substantially absent from the second number of historic social media posts.

3. The method of claim 1, wherein the historic viral event comprises, at least one of, a rate of growth, a rate of change of growth, an impact induced by a highly influential poster.

4. The method of claim 1, wherein the historic viral signature further comprises:
a first and second post within a chain of posts having substantially identical sentiment and subject; and
the first post and second post are distinguished by, at least one of, a time greater than a predetermined threshold, a geographic distance beyond a predetermined threshold, a number of intervening posts, and different social media websites.

5. The method of claim 1, wherein the number of current social media posts and the historic viral signature comprises a first spike in at a local time in a first time zone and a second spike at substantially at the same local time in a second time zone.

6. The method of claim 1, wherein the historic viral signature comprises, at least one of, a subject and a keyword of a root post of the first number of the historical social media posts substantially originating the historic viral event.

7. The method of claim 1, wherein the first response comprises a post to contradict at least one of the number of current social media posts.

8. The method of claim 1, wherein the first response comprises signaling an agent to contact a creator of at least one of the number of current social media posts.

9. The method of claim 1, wherein the number of current social media posts and the historic viral signature comprises a velocity.

10. The method of claim 9, wherein the number of current social media posts and the historic viral signature comprises rate of change of the velocity.

11. The method of claim 1, further comprising:
waiting a predetermined amount of time following the first response, and then:
monitoring the social media website for the number of current social media posts;
determining the degree of a second match between the number of current social media posts and the historic viral signature; and
upon determining the degree of the second match indicates the current viral event, performing a second response.

12. A system, comprising:
a processor;
a database
a network connection operable to connect the processor to a social media website;
wherein the processor is operable to access a number of historical social media posts, select a historic viral event comprising a first number of the historical social media posts;
identify a historic viral signature from the historic viral event; and populate a database with the historic viral signature.

13. The system of claim 12, wherein the processor is further operable to monitor a social media website for a number of current social media posts, determining the degree of a first match between a number of current social media posts and the historic viral signature, and upon determining the degree of the first match indicates a current viral event, performing a first response.

14. The system of claim 13, further comprising:
an agent; and
wherein the first response is a signal to the agent to perform an operation to modify the current viral event.

15. A non-transitory computer readable medium with instructions, that when read by a computer cause the computer to perform the following method:
accessing a number of historical social media posts;
selecting a historic viral event comprising a first number of the historical social media posts;
identifying a historic viral signature from the historic viral event;
monitoring a social media website for a number of current social media posts;
determining the degree of a first match between the number of current social media posts and the historic viral signature; and
upon determining the degree of the first match indicates a current viral event, performing a first response.

16. The instructions of claim 15, wherein the historic viral event comprises, at least one of, a rate of growth, a rate of change of growth, an impact induced by a highly influential poster.

17. The instructions of claim 15, wherein the historic viral signature further comprises:
a first and second post within a chain of posts having substantially similar sentiment and content; and
the first post and second post are distinguished by, at least one of, a time greater than a predetermined threshold, a geographic distance beyond a predetermined threshold, a number of intervening posts, and different social media websites.

18. The instructions of claim 15, wherein the number of current social media posts and the historic viral signature comprises a first spike in at a local time in a first time zone and a second spike at substantially at the same local time in a second time zone.

19. The instructions of claim 15 wherein the historic viral signature comprises, at least one of, a content and a keyword of a root post of the first number of the historical social media posts originating the historic viral event.

20. The instructions of claim 15, further comprising:
waiting a predetermined amount of time following the first response, and then:
monitoring the social media website for the number of current social media posts;
determining the degree of a second match between the number of current social media posts and the historic viral signature; and
upon determining the degree of the second match indicates the current viral event, performing a second response.
